(19) United States
(12) Patent Application Publication
(10) Pub. No.: US 2009/0136017 A1
(43) Pub. Date: May 28, 2009

(54) SYSTEM AND METHOD FOR PROCESSING TELECOMMUNICATION CALLS

(75) Inventor: Guillaume Hoareau, Montpellier (FR)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 12/265,433

(22) Filed: Nov. 5, 2008

(30) Foreign Application Priority Data
Nov. 27, 2007 (FR) 07301590.1

(51) Int. Cl. H04M 3/42

(52) U.S. Cl. 379/216.01

(57) ABSTRACT

A system and method are disclosed for processing calls in a telecommunication network. The system may comprise a plurality of terminals, wherein each of the plurality of terminals has an input for receiving a call request including a set of keywords, and wherein the plurality of terminals comprises a calling terminal and a set of destination terminals. The system further may comprise a call processing server for establishing communication between the calling terminal and the set of destination terminals in response to the reception of a call request from the calling terminal. The call processing server may comprise a management table, an alias resolution unit, an analyzer unit, and a switching subsystem.

### RELATED APPLICATION

This application claims priority under 35 U.S.C. §119 to European Patent Application No. 07301590.1 filed Nov. 27, 2007, the entire text of which is specifically incorporated by reference herein.

### FIELD OF THE INVENTION

The various embodiments described herein generally relate to a system and a method for processing telecommunication calls.

### BACKGROUND OF THE INVENTION

With conventional systems and methods for processing telecommunication calls, a caller party wishing to call a desired party must compose a phone number consisting of a set of digits that he has previously memorized or copied into a telephone directory. The call request carrying the phone number is then processed by a telephone switching unit that connects the caller to the desired party. The caller party is thus required to memorize the phone numbers or to maintain a telephone directory.

Other existing systems provide a local contact list structure within the phone cell for storing a number of mnemonics aliases, such as people, group names, or service names, each alias being associated with a phone number. The caller party wishing to call a particular entity must find the alias attached thereto and select it. After the corresponding phone number is retrieved, the phone number is transmitted to the telephone switching unit to connect the caller party with the entity corresponding to the alias. This solution avoids phone number memorization. However, the memory available in the telephone device is limited, and thus the number of entries that a user may register in the contact list is restricted. Furthermore, this solution only permits association of a unique phone number with a given destination entity and accordingly does not enable the caller to concurrently call multiple destination entities.

Other systems and methods for processing calls have been provided in the prior art to simplify the operation of dialing phone numbers. For example, U.S. Publication No. 2005/0153717 provides a system and a method for directly connecting a caller to a special operator center in response to a call request emitted by the caller in the form of a Short Message Service (SMS) containing a descriptive name of the destination party. The operator center comprises a database storing names of previously registered customers along with their corresponding telephone numbers. The operator center connects the caller to the destination entity if the description name contained in the request matches a phone number. This solution requires complex systems for ensuring SMS request exchanges and analysis, and therefore does not allow for a direct call to a destination party. Moreover, this solution involves a complex conversational protocol that renders call processing long and costly. Furthermore, this solution is not transparent to the caller; rather, the caller is prompted to perform a number of actions such as selecting the operators or the mobile providers responsible for request processing.

Another system is known from U.S. Pat. No. 6,463,147, which provides a telephone switching network for receiving a call request in the form of a string of characters from a caller party and for retrieving the telephone number that matches the string. The network includes a set of switching units, with each switching unit maintaining its own record of the telephone numbers assigned to the telephone sets connected to such switching unit. On finding a successful match, the caller is connected with the appropriate destination entity. This system allows a given switching unit to determine whether there exists a telephone number associated with a name in the look-up directories maintained by the other switching systems. However, this system is specific to PBX (Personal Branch Exchange) technology and requires complex exchanges between the switching units. Moreover, this solution does not permit a user to be connected to more than one party through a unique call. Furthermore, this solution generates a failure message if the string of characters entered by the user does not match any telephone number.

Another method is known from U.S. Pat. No. 7,054,621, which provides a method for establishing communications with multiple communication devices. This method initiates a multiparty call by sending an identifier representing a group to a mobile base station. A storage device associated with the mobile base station contains the contact details of the members of the multiparty group. The telephone numbers of all of the group members are retrieved, and a conference call is established with the caller. Thus, this method allows connection with multiple parties using a unique request. However, several actions are required from the caller to obtain connection. Specifically, the user must select each desired destination entity by entering each time the corresponding alias in the phone interface. Moreover, this method requires that the aliases be previously stored in the local directory of the user phone. This method only makes it possible to locally offload the contact details from the directory stored in the user phone. Therefore, it is not possible to establish links between the local directories of several user phones.

The various embodiments described herein overcome the problem of conventional systems presented by the prior art, as will be described in greater detail below.

### SUMMARY OF THE INVENTION

In order to address the problems presented by the prior art, a system and method for processing telecommunication calls are provided in the disclosure and in the appended independent claims. Additional exemplary embodiments are provided in the dependent claims.

The various embodiments provide an alternative to conventional dialing methods and make it possible to concurrently establish a communication with multiple users, in a transparent and dynamic manner, from a call request emitted by the caller in the form of a set of keywords.

The various embodiments also make it possible to determine the more relevant interlocutors for the caller in the event that there is no direct matching, based on the needs expressed by the set of keywords.

The various embodiments also obviate the need for a complex conversational protocol. The user merely needs to perform one action to directly start a multiparty communication or connection, and the user may use a set of intuitive keywords instead of a regular phone number.

Further advantages of the various embodiments will become clear to the skilled person upon examination of the drawings and detailed description. It is intended that any auxiliary advantages be incorporated herein.

### BRIEF DESCRIPTION OF THE DRAWINGS

Exemplary embodiments will now be provided with reference to the accompanying drawings in which like references denote similar elements. In the drawings:

FIG. 1 provides a schematic representation of a call processing system according to an exemplary embodiment;

FIG. 2 provides a detailed view of the call processing system represented in FIG. 1 according to an exemplary embodiment;

FIG. 3 provides an implementation of the call processing system according to an exemplary embodiment;

FIG. 4 provides the call processing system according to another exemplary embodiment;

FIG. 5 provides a management table of the call processing system according to an exemplary embodiment;

FIG. 6 provides a flowchart showing the steps performed by an alias resolution unit of the call processing system according to an exemplary embodiment; and

FIG. 7 provides a flowchart showing the steps performed by an analyzer unit of the call processing system according to an exemplary embodiment;

### DETAILED DESCRIPTION

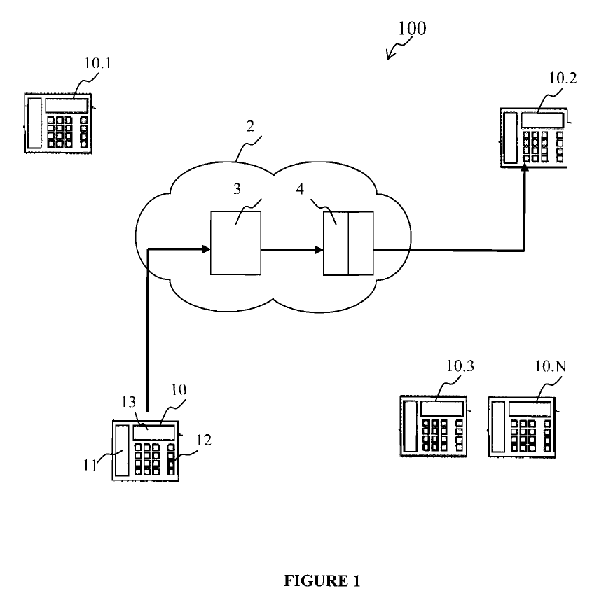

FIG. 1 depicts a telecommunication system 100 including a calling telecommunication terminal 10 used for communication with a set of destination telecommunication terminals 10.1, 10.2, 10.3, . . . , 10.N through a telecommunication network 2. The telecommunication terminals 10.1, 10.2, 10.3 . . . , 10.N will be commonly referred to as “10.i”, where index “i” designates any of the indices 1 to N. The telecommunication terminals 10 and 10.i may be any type of analog or digital telephone equipment compliant with the telecommunication network 2, such as a cordless telephone, a cellular telephone, a personal digital assistant (PDA), a VoIP (Voice over Internet Protocol) hardphone or softphone, or the like.

Each telecommunication terminal 10, 10.i comprises input and output components. The input and output components may include a handset 11 with a loudspeaker and a microphone, and a keypad 12 with buttons for input to the telephone sets. The keypad 12 may be used for entering a call request in the form of a set of keywords, validating commands, initiating and terminating calls, and performing control operations. The terminals may also include speech recognition capabilities in order to allow the calling party to enter the call request vocally.

The terminals 10 and 10.i may also include a display 13 to provide visual messages to the user.

The terminals 10 and 10.i may also include a processing unit for encoding and decoding control signals, performing call processing procedures, and controlling operation of the terminals.

The telecommunication terminals 10 and 10.i are connected via wired or wireless connections to the telecommunication network 2.

The telecommunication network 2 may be any type of telecommunication network enabling a synchronous or asynchronous communication between the calling telecommunication terminal 10 and one or more destination telecommunication terminals 10.i. For example, the telecommunication network 2 may be a fixed wired network, a PSTN network (Public Switched Telephone Network), or an ISDN network (Integrated Services Digital Network). Alternatively, the telecommunication network 2 may be a mobile telecommunication network or cellular phone network, e.g., according to GSM standard (Global System for Mobile Communications) or UMTS standard (Universal Mobile Telecommunications System). The telecommunication network 2 may also be an IP-based network implementing VoIP for routing of voice conversations.

The telecommunication network 2 comprises a switching subsystem 4 for establishing connection and relaying speech information between the calling terminal 10 and one or more destination terminals 10.i.

In a non-cellular exemplary embodiment, the switching subsystem 4 may be a telephone exchange. The telephone exchange may be a public exchange operated by a telephone company for many businesses and/or the general public or may be a private exchange such as a private branch exchange (PBX) that serves a particular business or office.

The telecommunication system 100 according to an exemplary embodiment also may include a call processing server 3 connected to the terminals 10 and 10.i through the telecommunication network 2. The call processing server may receive call requests from the terminals in the form of a set of keywords and may determine from the call requests which destination terminals 10.i are to be connected with the calling terminal 10. Moreover, the call processing server 3 may be provided to identify the phone numbers of the destination parties and to transmit them to the switching subsystem 4 for connection. The switching subsystem 4 then may establish the communication between the calling terminal 10 and the destination terminals 10.i.

The calling party wishing to speak to one or several destination parties may push the keypad buttons of his terminal 10 or may emit a vocal command in order to enter the call request in the form of a set of keywords. The calling terminal 10 then may generate a request signal containing the requested set of keywords for transmission to the call processing server 3. The call processing server 3 then may determine the relevant destination numbers from the requested set of keywords to the switching subsystem 4. The switching subsystem 4 then may determine whether the destination terminals corresponding to the destination phone numbers are active (not on hook) and if so may connect the caller line to the destination terminals.

Accordingly, a call from a calling terminal 10 to the desired destination terminals 10.i may occur without the calling party having possession of the actual telephone numbers of the destination parties. The string of keywords forming the call request need not be previously remembered or stored in a directory. The calling party may guess the keywords forming the call request based on intuition. The calling party may enter as many keywords as desired, unless a maximum number of keywords is predefined in the system. Moreover, the call request is not limited by the order of the keywords.

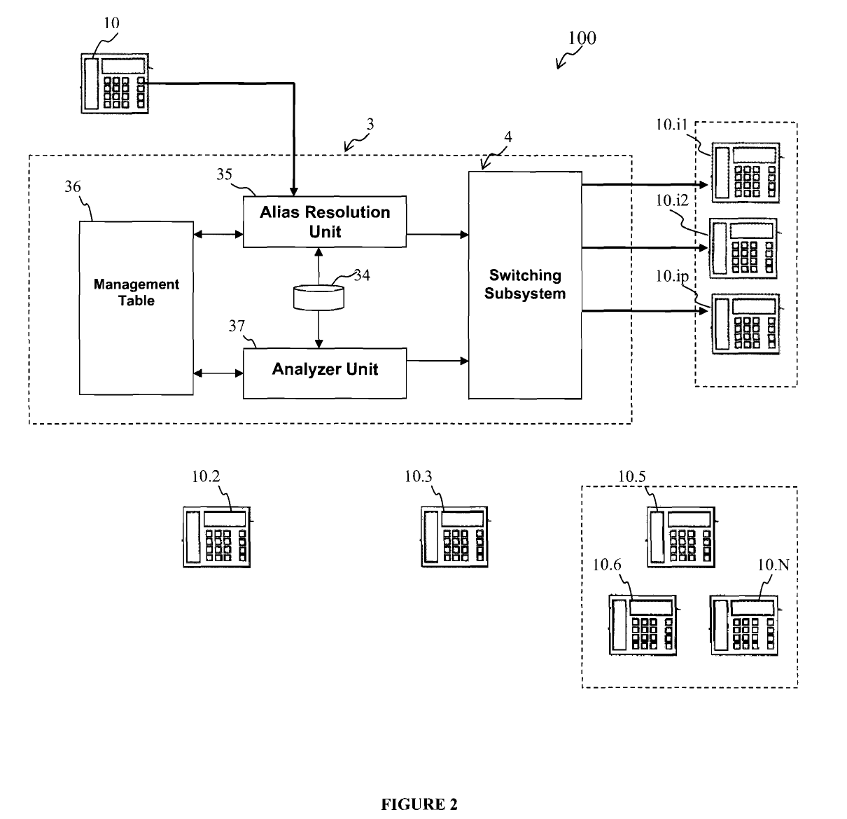

FIG. 2 provides the structure of the telecommunication system 100 in detail according to an exemplary embodiment. The call processing server 3 may include an alias resolution unit 35 for determining destination entities (a person, a group of persons, or a service) based on a call request received from a calling terminal 10 in the form of a string of keywords K1={K11, . . . , K1i, . . . , K1N}.

The alias resolution unit 35 may be adapted to determine whether the string of keywords matches an alias of a destination entity, and if so the unit may be adapted to determine the corresponding phone numbers for transmission to the switching subsystem 4. The switching subsystem 4 then may establish communication between the calling terminal 10 and the desired destination terminals 10.i1 to 10.ip.

Furthermore, the call processing server 3 may include a management table 36 that interacts with the alias resolution unit 35. The management table 36 may contain one or more entries respectively associated with existing terminals of the telecommunication network 2. Each entry may have an alias parameter in association with one or more phone numbers. The alias parameter may consist of alphanumeric characters.

More specifically, the alias resolution unit 35 may determine whether the set of keywords entered by the calling terminal, considered as a whole, matches the alias associated with an entry in the management table 36. If the alias resolution unit 35 determines that no entry in the management table 36 matches the call request as a whole, or if the alias resolution unit 35 determines that more than one entry in the management table 36 match the call request as a whole, then the alias resolution unit 35 may transmit the call request to an analyzer unit 37.

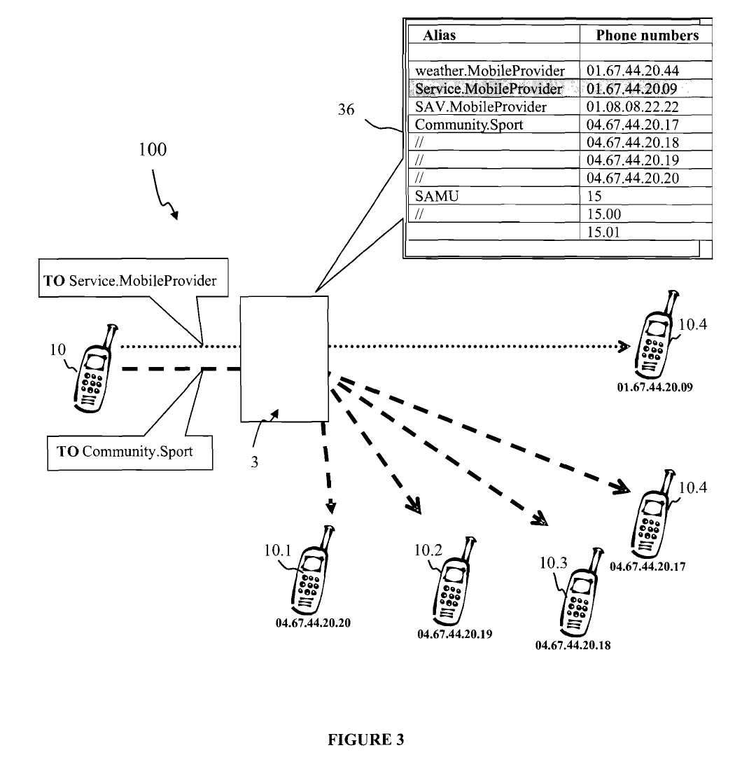

FIG. 3 provides a simplified configuration of the telecommunication system 100 according to an exemplary embodiment. The management table 36 in FIG. 3 depicts two columns, “Alias” and “Phone numbers”. In this exemplary configuration, the “Alias” field contains domain names such as “weather.MobileProvider”. As a result of the interaction between the management table 36 and the alias resolution unit 35, a calling party may enter a keyword-based call request and as a result may be connected to the desired destination terminal or terminals. For instance, a calling party wishing to call the Mobile Provider Service entity may enter a call request consisting of “Service.MobileProvider” at the calling terminal 10 and as a result may be connected with the destination terminal 10.4 by the alias resolution unit 35. Similarly, a calling party wishing to call the members of the community sport may enter a call request consisting of “Community.Sport” and as a result may be connected with the destination terminals 10.1, 10.2, 10.3 and 10.4 by the alias resolution unit 35.

Referring back to FIG. 2, the analyzer unit 37 may be adapted to process separately each keyword of the call request in order to select relevant entries from the management table 36. Then, the analyzer unit 37 may determine which destination entities among the selected entries are to be connected with the calling terminal 10 based on predefined rules.

The management table 36 may associate a set of auxiliary keywords with each entry. Thus, the analyzer unit 37 may check the auxiliary keywords associated with each entry of the management table 36 to select the relevant entries.

The analyzer unit 37 may transmit the phone numbers of the desired destination terminals to the switching subsystem 4. The switching subsystem 4 may then determine whether the desired destination terminals are available for communication and if so start the communication therewith.

If the analyzer unit 37 fails to find a relevant entry in the management table 36, or if the desired destination parties are not available for communication, then the call processing server 3 may transmit a failure signal to the calling terminal 10 for generation of a failure message to the caller, such as a displayed text message or a vocal message indicating that the request cannot be fulfilled.

The alias resolution unit 35 and the analyzer unit 37 may maintain a common selection table 34 in which they store entries selected from the management table 36.

The above description has been made with reference to a unique telecommunication network 2. However, the system according to an exemplary embodiment may also include a combination of networks, wherein one or more cellular telephone networks may coexist with one or more non-cellular networks or with one or more Internet Protocol (IP) networks.

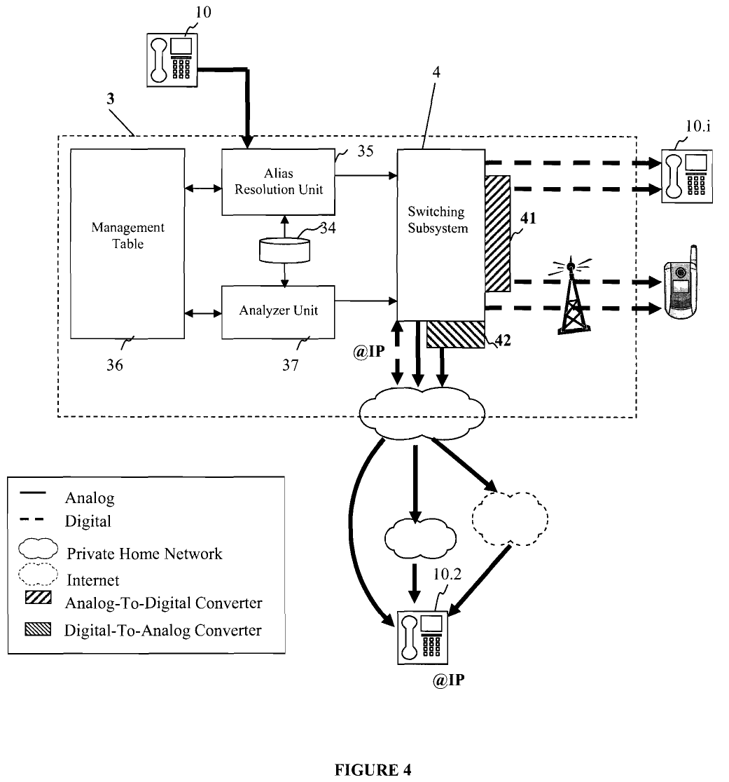

FIG. 4 illustrates an exemplary embodiment in which a combination of networks is used. The calling terminal 10 belongs to a first internal network.

In such an exemplary embodiment, additional telecommunication components and network resources may be provided close to the switching subsystem 4 to facilitate linking the different networks. These components may include, but are not limited to, an analog-to-digital converter 41 and a digital-to-analog converter 42.

To manage communication between a cellular telephone network and a non-cellular telephone network, the switching subsystem 4 may order conversion from analog to digital communication or from digital to analog communication.

To join a terminal 10.2 having an IP address belonging to a different network, the switching subsystem 4 may request the local network 2 to determine whether the IP address is known. If the IP address is known, the local network may route the communication to the appropriate network, which then may deliver the call request to the appropriate terminal 10.2.

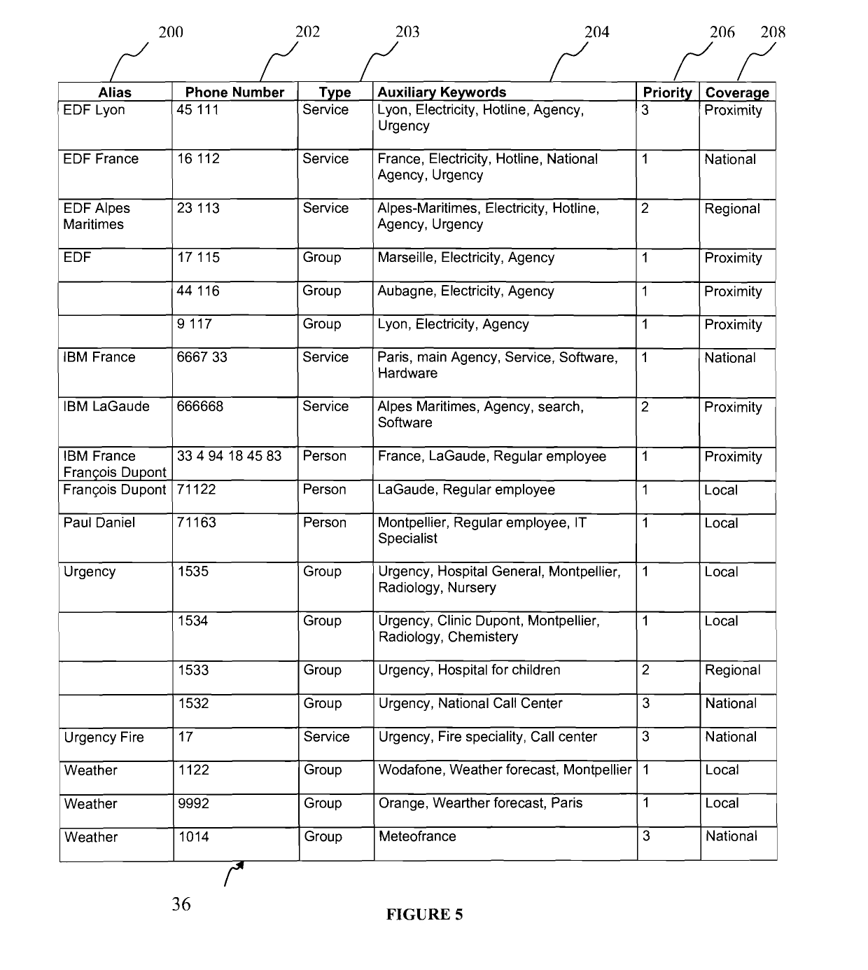

FIG. 5 provides the management table 36 according to an exemplary embodiment. The management table 36 provides a number of entries, with each entry comprising:

an “Alias” parameter 200, containing a destination entity name consisting of a set of alphanumeric characters (e.g., “EDF France”);

a “Phone Number” parameter 202, containing one or more phone numbers in association with each alias;

a “Type” parameter 203, indicating the type of the destination entity named in the alias field (e.g., “Service”, “Group”, “Person”);

an “Auxiliary Keywords” parameter 204, containing a set of keywords which are related with each alias (e.g., the keyword set “France, Electricity, Hotline, National Agency, Urgency” for alias “EDF France”);

a “Priority” parameter 206, associating a priority value with the alias (e.g., “1”, “2”, “3”, etc.); and

a “Coverage” parameter 208, indicating whether the coverage of the entity designated by the alias is “World Wide”, “National”, “Regional”, “Local,” “Proximity”, etc.

The “Coverage” parameter 208 associated with an entry indicates whether the entry is relevant to cover “Proximity”, “Local”, “Regional”, “National”, or “World Wide” requests. Accordingly, the rules for selecting the destination terminals may include a rule related to the “Coverage” parameter 208 in order to take into account the proximity of the destination candidates.

The “Priority” parameter 206 may be set up by the internet provider. The rules for selecting the destination terminals may include a priority rule related to the “Priority” parameter 206, in order to take into account the entries having the higher priority values. This parameter allows a destination entity such as a company to ensure that it will be selected based on priority for a given search.

The fields maintained in the management table 36 are used to apply the predefined selection rules. The analyzer unit 37 may apply the predefined rules incrementally. Accordingly, if the application of a first rule provides more than one result, the alias resolution unit may apply the next rule as appropriate. Examples of predefined rules for incremental application are provided below. If the keyword-based call request input by the calling party does not match any “Alias” parameter in the management table 36, or if the set of keywords matches the “Alias” parameter of more than one entry in the management table 36, then the following rules may be applied incrementally, starting with Rule 1. It is important to note that the following rules are exemplary in nature and thus are not intended to limit the scope of possible rules that may be applied.

Rule 1 Related to the “Auxiliary Keywords” Parameter:

The set of keywords is the expression of the needs of the calling party. If the set of keywords input by the calling party matches at least one keyword in the “Auxiliary Keywords” parameter of an entry in the management table 36, the entry is selected and placed into the selection table 34. If the selection table 34 exceeds a predefined number of selected entries, other rules may be applied to improve the selection. If there is more than one entry in the selection table 34, the analyzer unit 37 then may apply Rule 2 to improve the selection as appropriate.

Rule 2 Related to the “Coverage” Parameter:

Rule 2 consists of selecting the closest entries from the selection table 34 based on the “Coverage” parameter of the management table. Accordingly, for example, an entry from the selection table having a “Proximity” value for the “Coverage” parameter may be selected over an entry having a “Local” value for the “Coverage” parameter; an entry from the selection table having a “Local” value may be selected over an entry having a “National” value; and an entry from the selection table having a “National” value may be selected over an entry having a “World Wide value. If Rule 2 still provides more than one result, then Rule 3 may be applied to improve the selection as appropriate.

Rule 3 Related to the “Priority” Parameter:

The selection may be further filtered based on the “Priority” parameter of the selected entries. For instance, the priority rule may consist in selecting the entries having the higher priority parameter values as appropriate.

In the management table 36, a single phone number may correspond to several entities (person, groups, services), and conversely a single entity may be associated with several phone numbers.

The management table 36 may include other data in association with each entry, such as a location parameter indicating the location of the corresponding entity, or a status parameter indicating whether the corresponding entity is busy or not.

The “Auxiliary Keywords” parameter and “Coverage” parameter of the management table 36 may be managed by the phone operator or mobile provider for companies, which may include but are not limited to entities of type “Group” or “Service”. Indeed, entities such as companies generally have their own Domain/Name suffix and prefix. They can communicate their prefix and suffix to all the mobile providers or fixed operators. For implementation of an exemplary embodiment in a local site, the “Auxiliary Keywords” parameter and “Coverage” parameter of the management table 36 may be alternatively managed by the system manager or the network manager.

The manager of the management table 36 (e.g., the phone operator, the mobile provider, the system manager, or the network manager) may add a new entry, delete an existing entry, or update the parameters of an existing entry. A keyword generator engine may be provided in the telecommunication system 100 for automatically generating the auxiliary keywords for a new entry, e.g, for entries having aliases that designate conventional entities, such as “hospital”, “police”, “doctor”.

The string of keywords in the “Auxiliary Keywords” field of the management table 36 may include a number of words separated with spacing characters. Exemplary keyword strings include the following:
“mobileProvider”: 1 word;
“fr sav mobileProvider”: 3 words separated by space characters;
“dallas tom Watson”: 3 words separated by space characters.

Additionally, the analyzer unit 37 may be connected to a text analyzer that may interact with databases to compare the keywords of the request with data contained in the databases and to retrieve information from the databases. The analyzer unit 37 then may use the retrieved information for selecting the relevant entries from the management table 36. The databases associated with the text analyzer may include a geographic database containing city names in association with geographic information. This embodiment is particularly suitable where the management table 36 includes a coverage field. The exemplary table below represents a simplified management table 36 comprising 3 entries, each having four parameters (“Alias”, “Phone Number”, “Coverage”, and “Priority”), with other fields such as “Auxiliary Keywords” not included:

| Alias | Phone Number | Coverage | Priority |
|---|---|---|---|
| EDF.France | 1011 | “National” | 3 |
| EDF.Marseille | 101113 | “Local” | 1 |
| EDF.SOUTH | 041011 | “Regional” | 2 |

In an exemplary scenario, assuming that the calling party inputs “EDF Marignane” as the set of keywords forming the call request, the alias resolution unit 35 will find that no entry in the management table 36 has an alias that matches the request “EDF marignane”.

The alias resolution unit 35 then may transmit the request to the analyzer unit 37, which in turn may submit the request to the text analyzer prior to applying the predefined rules for textual analysis. The text analyzer then may parse the request and submit “Marignane” to the geographic database. The geographic database will determine that “Marignane” is a city and accordingly may return the associated geographic information to the analyzer unit 37. The analyzer unit 37 then may compare the geographic information of the city “Marignane” with the entry fields of the management table 36 that have a “Coverage” parameter different from “Local”. Thus, the entry having the alias “EDF.Marseille” will not be selected on the grounds of its “Local” coverage. On the contrary, “EDF.SOUTH”, which covers the entire south area of France, and “EDF.France”, which covers all of France, will be selected, since both match the geographic information. Finally, the analyzer unit 37 may select only the entry “EDF.SOUTH”, since this is the closest entry to the city “Marignane” based on the geographic information retrieved.

In the event that the resulting selection would include more than one matching entry, a rule related to the “Priority” parameter could be further applied. If there still remains more than one entry after applying the predefined rules, the analyzer unit 37 may select the first entry in the selection table 34 for connection to the calling terminal as desired.

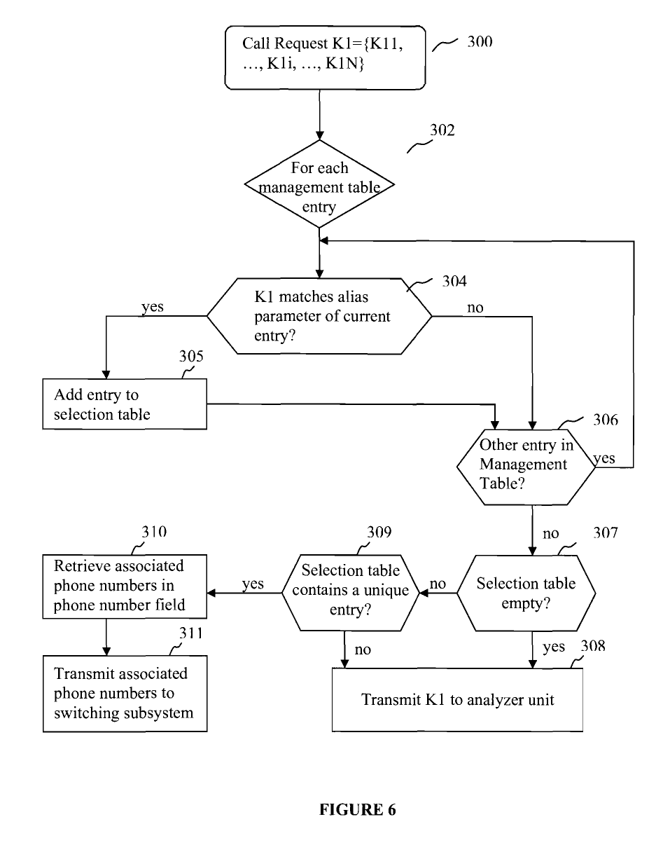

FIG. 6 provides a flowchart illustrating the steps that may be performed by the alias resolution unit 35 to connect the calling terminal 10 to desired destination entities according to an exemplary embodiment.

At step 300, a call request K1={K11, . . . , K1i, . . . , K1N} including a set of keywords may be received from the caller at the calling terminal 10. The set of keywords may be entered by the user using the keypad keys of the terminal 10 or vocally through the microphone before processing by speech recognition means. A signal carrying the set of keywords then may be transmitted from the calling terminal 10 to the alias resolution unit 35.

At step 302 the alias resolution unit 35 may select a first entry of the management table 36 and then at step 304 may determine whether the call request K1 matches the alias of the first entry.

If the call request K1 matches the alias of the first entry, then at step 305 the alias resolution unit 35 may add the entry to the selection table 34. Then, at step 306 the alias resolution unit 35 may determine whether the management table 36 contains other entries. If so, steps 304 to 306 may be repeated for the next entry in the management table 36. If there is no other entry in the management table 36, then the alias resolution unit 35 may determine whether the selection table 34 is empty at step 307. If the selection table 34 is not empty, then at step 309 the alias resolution unit 35 may determine whether the selection table 34 contains a unique entry (i.e., one and only one entry).

If the selection table 34 contains a unique entry, at step 310 the alias resolution unit may retrieve the phone numbers associated with the matching entry in the “Phone Number” field and then at step 311 may transmit the associated phone numbers to the switching subsystem 4. The switching subsystem 4 may check the availability of the destination entities corresponding to the phone numbers and accordingly may establish the communication.

If the selection table contains more than one entry (i.e., the call request K1 matches the “Alias” parameter of more than one entry) at step 309 or if the selection table has been determined as empty at step 307, then at step 308 the alias resolution unit 35 may transmit the call request K1 to the analyzer unit 37 for further processing.

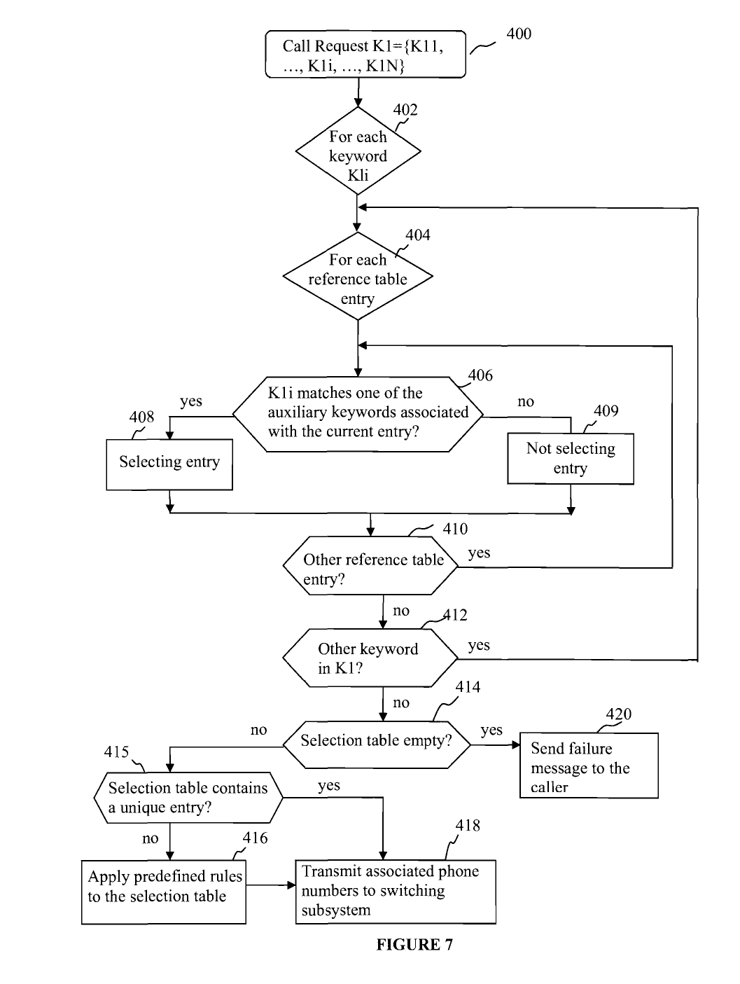

FIG. 7 provides a flowchart illustrating the steps that may be performed by the analyzer unit 37 according to an exemplary embodiment.

At step 400 the analyzer unit 37 may start processing the call request K1={K11, . . . , K1i . . . , K1N} received from the alias resolution unit 35.

The analyzer unit 37 may process each keyword K11, . . . , K1i . . . , K1N of the string K1 separately. Accordingly, at step 402 the analyzer unit 37 may select a keyword K1i. Then, at step 404 the analyzer unit 37 may begin processing the entries of a reference table. The reference table may be the management table 36 if the selection table 34 is empty (i.e., the alias resolution unit 35 has found no matching entry—see above discussion with reference to FIG. 6) or may be the selection table 34 if the selection table 34 is not empty (i.e., the alias resolution unit 35 has found more than one matching entry—see above discussion with reference to FIG. 6). That is to say, at step 404, for the current keyword K1i, the analyzer unit 37 may begin processing the first entry of the reference table, which is either the management table 36 or the selection table 34 depending upon the number of matching entries found by the alias resolution unit 35.

At step 406, the analyzer unit 37 may compare the current keyword K1i with the auxiliary keywords associated with the entry being processed and may determine whether the current keyword K1i matches one of the auxiliary keywords. If the current keyword K1i matches one of the auxiliary keywords associated with the current entry, then at step 408 the analyzer unit 37 may select the current entry. Such selection may include adding the entry to the selection table 34 if the reference table is the management table 36 or maintaining the entry in the selection table 34 if the reference table is the selection table.

If the current keyword K1i does not match any auxiliary keyword associated with the current entry, then at step 409 the current entry may not be selected. Such non-selection may include removing the entry from the selection table 34 if the reference table is the selection table.

Then, the analyzer unit 37 may process the remaining entries of the reference table. Accordingly, at step 410, the analyzer unit 37 may determine whether the reference table contains further entries. If so, steps 406 to 410 may be repeated for the same keyword K1i and the next entry in the reference table.

When all the entries of the reference table have been processed, the analyzer unit 37 may determine whether the call request K1 contains other keywords and if so may repeat steps 404 to 412 for the next keyword of K1.

Once all of the keywords K1i have been processed, at step 414 the analyzer unit 37 may determine whether the selection table is empty. If the selection table is empty, at step 420 the analyzer unit 37 may display a failure message to the calling terminal to inform the caller that the requested communication has failed.

If the selection table is not empty, then at step 415 the analyzer unit 37 may determine whether the selection table contains a unique entry. If not (i.e., the selection table contains a plurality of selected entries), then at step 416 the analyzer unit 37 may apply predefined rules incrementally as appropriate to select a unique entry among the selected entries as the destination entry (see the aforementioned exemplary rules). If the selection table contains a unique entry, processing may proceed directly to step 418.

At step 418 the analyzer unit 37 may transmit the phone numbers associated with the unique destination entry to the switching system 4, and the switching system 4 in turn may ensure establishment of the communication.

The various embodiments described herein make it possible for a calling party to be concurrently connected with a plurality of destination parties, with no need to remember their phone numbers or to retrieve the phone numbers from a directory. The system and the method of processing calls described herein efficiently ensure such communication connections in a transparent manner for the calling party. Indeed, the only actions required from the calling party are to enter a call request consisting of intuitive keywords and to press the start connection button of the relevant telephone.

Furthermore, in accordance with the various embodiments, the calling party is not required to enter a specific word but rather may deliberately enter a set of keywords to start a single party communication or a multiparty conference communication. The calling party is not required to make selections or choose the operator or mobile providers for processing the call request. Accordingly, the various embodiments further obviate the need for a complex conversational protocol. The calling party may reach several destination parties with only one call request.

The various embodiments may be realized in hardware, software, or a combination of hardware and software. A call processing system according to the various embodiments may be realized in a centralized fashion in a computer system, or in a distributed fashion wherein different elements are spread across several interconnected computer systems. Any type of computer system or other apparatus adapted for carrying out the method described herein is suitable. A typical combination of hardware and software may be a general purpose computer system with a computer program that, upon being loaded and executed, controls the computer system such that it carries out the methods described herein.

The various embodiments may also be embedded in a computer program product that comprises all the features enabling the implementation of the methods described herein, and which, when loaded in a computer system, is able to carry out these methods.

The foregoing is considered as illustrative only of the principles of the various embodiments. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. For example, those skilled in the art will appreciate that the management table provided in FIG. 5 is for exemplary purposes only, and that other types of management tables may be used alternatively. Moreover, the various embodiments are not limited to the telecommunication networks described above and are applicable to existing types of telecommunication networks. Furthermore, those skilled in the art will appreciate that the various embodiments are not limited to the aforementioned predefined rules and may comprise other types of rules in lieu of or in addition to the aforementioned rules.

1. A system for processing calls in a telecommunication network comprising:
a plurality of terminals, wherein each of the plurality of terminals comprises an input for receiving a call request comprising a set of keywords, and wherein the plurality of terminals comprises a calling terminal and a set of destination terminals; and
a call processing server for establishing communication between the calling terminal and the set of destination terminals in response to the reception of a call request from the calling terminal, wherein the call processing server comprises:
a management table storing entries that associate an alias with at least one phone number identifying a destination terminal and with a set of auxiliary keywords;
an alias resolution unit for selecting an entry from the management table in response to the set of keywords of the call request matching the alias of the entry;
an analyzer unit for selecting an entry from the management table in response to at least one keyword of the set of keywords of the call request matching at least one auxiliary keyword of the set of auxiliary keywords of the entry; and
a switching subsystem for initiating communication between the calling terminal and the set of destination terminals, wherein the set of destination terminals is identified by the at least one phone number associated with at least one of the selected entries.

2. The system according to claim 1, wherein the analyzer unit is provided to compare each keyword of the set of keywords of the call request to the set of auxiliary keywords associated with each entry of the management table and to store each selected entry in a selection table.

3. The system according to claim 2, wherein the analyzer unit is provided to select at least one candidate entry among the entries stored in the selection table based on predefined rules and to transmit the at least one phone number associated with the at least one selected candidate entry to the switching subsystem.

4. The system according to claim 3, wherein the management table further associates a priority parameter with each entry, and wherein one of the predefined rules is related to the priority parameter of the entries stored in the selection table.

5. The system according to claim 3, wherein the management table further associates a location parameter with each entry, and wherein one of the predefined rules is related to the location parameter of the entries stored in the selection table.

6. The system according to claim 1, wherein the call processing server transmits a failure message to the calling terminal if the analyzer unit fails to select one entry from the management table.

7. The system according to claim 1, wherein the set of auxiliary keywords of each entry stored in the management table comprises a number of words consisting of alphanumeric characters.

8. The system according to claim 1, wherein the alias of each entry stored in the management table consists of a word comprising alphanumeric characters.

9. The system according to claim 1, wherein the telecommunication network comprises a fixed wired network.

10. The system according to claim 1, wherein the telecommunication network comprises a mobile network.

11. The system according to claim 1, wherein the telecommunication network comprises a VoIP network.

12. A method for processing calls in a telecommunication network among a plurality of terminals comprising a calling terminal and a set of destination terminals, wherein the telecommunication network comprises a management table storing entries that associate an alias with at least one phone number identifying a destination terminal and with a set of auxiliary keywords, and wherein the method comprises:
receiving a call request comprising a set of keywords;
selecting an entry from the management table in response to the set of keywords of the call request matching the alias of the entry;
selecting an entry from the management table in response to at least one keyword of the set of keywords of the call request matching at least one auxiliary keyword of the set of auxiliary keywords of the entry; and
initiating communication between the calling terminal and the set of destination terminals, wherein the set of destination terminals is identified by the at least one phone number associated with at least one of the selected entries.
